(19) United States
(12) Patent Application Publication
(10) Pub. No.: US 2008/0052682 A1
(43) Pub. Date: Feb. 28, 2008

(54) Debug device and debug processing method

(76) Inventor: Satoshi Nagamine, Kyoto (JP)

Correspondence Address: MCDERMOTT WILL & EMERY LLP, 600 13TH STREET, NW, WASHINGTON, DC, 20005-3096, US

(21) Appl. No.: 11/889,823

(22) Filed: Aug. 16, 2007

(30) Foreign Application Priority Data
Aug. 25, 2006 (JP) 2006-228797

(51) Int. Cl. G06F 11/36; G06F 9/44

(52) U.S. Cl. 717/129

(57) ABSTRACT

The debug device of the present invention comprises a debugger and a target. The debugger comprises a break instruction setting part that writes a break instruction to a breakpoint when receiving a request for executing break instruction writing processing, and a program control part for starting up the target. The target comprises: a first storage device for storing a program as a debug target; a second storage device which is a loading destination of the program; and a loader which loads the program from the first storage device to the second storage device, and informs completion of loading to the debugger when the loading is completed so as to request break instruction writing processing.

### BACKGROUND OF THE INVENTION

1. Field of the Invention

The present invention relates to a debug device and a debug processing method used in software development for built-in devices. More specifically, the present invention relates to a technique for improving the debugging work efficiency in a system where a program is loaded to a memory capable of high-speed operation during startup for high-speed access.

2. Description of the Related Art

In debugging software of a built-in device, a breakpoint at which a program is turned off during the execution of the program is set, and a break instruction is written to that breakpoint. In doing so, the program is executed until that breakpoint, and the operation thereof is halted at the breakpoint, and then details of variables as well as contents of memory are checked.

In software for a built-in device that requires high-speed processing, there is such a type that a program stored in a ROM or a flash memory is loaded to a memory that is capable of high-speed access such as SDRAM (Synchronous Dynamic Random Access Memory), and then the program is executed thereon. When debugging such program, a break instruction is written after confirming that the program is already loaded. Further, some of conventional debug devices are such a type that a break instruction is written on a memory to which a program is stored. This type of conventional debug device can be found in Patent Document (Japanese Unexamined Patent Publication 2003-345624).

If a break instruction is written to a memory at a loading destination before loading the program thereto, the break instruction written earlier is overwritten and erased when the program is loaded. Then, the program cannot be halted at the breakpoint. Therefore, a debug operator needs to write the break instruction after confirming that the program has already been loaded.

In order to confirm that the program has already been loaded, it is necessary to know the timing of loading the program or in some cases to know the address at a loading destination. In so doing, debugging work becomes complicated.

### SUMMARY OF THE INVENTION

The main object of the present invention therefore is to enable writing of a break instruction, even if the debug operator does not know the timing of loading a program and the address at a loading destination.

In order to overcome the foregoing issues, a debug device according to the present invention comprises: a debugger and a target, wherein:
the debugger comprises
a break instruction setting part which writes a break instruction to a breakpoint when receiving a request for executing break instruction writing processing, and
a program control part for starting up the target; and
the target comprises
a first storage device for storing a program as a debug target,
a second storage device which is a loading destination of the program, and
a loader which loads the program from the first storage device to the second storage device, and informs completion of loading to the debugger when the loading is completed so as to request the break instruction writing processing.

In this structure, the loader reads out the program stored in the first storage device and loads it to the second storage device. Upon confirming the completion of loading, the loader informs the completion of loading to the brake instruction setting part and requests the break instruction writing processing. Upon being informed about the completion of loading and receiving the request for executing the break instruction writing processing, the break instruction setting part writes the break instruction to the breakpoint that is stored in the second storage device. When writing of the break instruction is completed, the program control part starts up the target.

As described above, it is defined in the present invention to follow such an order that the program is loaded first, and the break instruction is written to the breakpoint thereafter. Therefore, in a system where a program is loaded to a memory capable of high-speed operation and executed during startup for high-speed access, it never happens that the break instruction is erased because of the load processing. As a result, the debug operator can write the break instruction automatically to the breakpoint without considering the timing of loading.

In the debug device of the above-described structure, there is such a form that:
the loader informs an address range of the second storage device to which the program is loaded, when requesting the debugger to execute the break instruction writing processing; and
the break instruction setting part writes the break instruction to the breakpoint that falls within the address range.

In this case, there is a corresponding relation between the program and the address range at the loading destination. That is, the break instruction is selectively written to the program that is already loaded. Therefore, in the case where there are a plurality of programs, the break instruction written earlier is not erased by the program loaded afterwards. In other words, in a system where a plurality of programs are loaded, it becomes possible to write a break instruction individually for each program even if each program is loaded to the same second storage device in different time zones.

Further, in the debug device of the above-described structure, there is such a form that:
a unique identifier is added to the program;
the loader informs the debugger about the identifier of the loaded program, when requesting the debugger to execute the break instruction writing processing; and
the break instruction setting part writes the break instruction to a breakpoint that matches the informed identifier.

In this case, the break instruction setting part reads out the breakpoint from the second storage device, and judges whether or not the identifier of the breakpoint matches the identifier informed by the loader. Then, the break instruction setting part writes the break instruction to that breakpoint only when the two identifiers match. Therefore, the break instruction written earlier is not erased by the program loaded afterwards.

Furthermore, in the debug device of the above-described structure, there is such a form that:
a unique identifier is added to the program;
the loader informs the debugger about the identifier of the loaded program and a start address of the second storage device to which the program is loaded, when requesting the debugger to execute the break instruction writing processing; and
the break instruction setting part writes the break instruction to an absolute address that is obtained as a result of adding the start address to a relative address held by breakpoint information.

The operation of this case will be described assuming that there is a plurality of programs. In the case of dynamic loading, the address of the loading destination is determined at the time of loading, which means that the address of the loading destination is not determined before the loading is executed. Even in such case, it is possible with this form to write the break instruction without considering the timing of loading the program and the address. This form is useful not only for the case of software break where the break instruction is written but also to the case of hardware break such as access break.

Moreover, in the debug device of the above-described structure, there is such a form that the debugger further comprises a load monitoring part, wherein
the load monitoring part stores information that loading is completed when receiving a notification about completion of the loading from the loader, and instruct the break instruction setting part to execute the break instruction writing processing if the loading of the program is completed when receiving a startup request from the program control part.

In this form, the loader reads out the program stored in the first storage device and loads it to the second storage device. After confirming the completion of loading, the loader informs the load monitoring part about the completion of loading. The load monitoring part stores information as to whether or not the loading of the program is completed. If the load monitoring part indicates that the loading is completed when the program control part starts up the load monitoring part, the load monitoring part instructs the break instruction setting part to write a break instruction. The break instruction setting part writes the break instruction to the breakpoint that is stored in the second storage device. When writing of the break instruction is completed, the program control part starts up the target. On the other hand, when the program loading is uncompleted, the load monitoring part does not instruct the break instruction setting part to write the break instruction. That is, the break instruction is not written. Through this, for the already loaded program, a break instruction can be written without starting up the loader. Therefore, it is possible to shorten the time that is required to start the execution of the program.

Further, a debug device according to the present invention comprises a debugger and a target, wherein:
the debugger comprises
a breakpoint registering part for registering breakpoint information, and
a program control part for starting up the target; and
the target comprises
a first storage device for storing a program as a debug target,
a second storage device which is a loading destination of the program,
a third storage device for storing the breakpoint information, and
a loader which loads the program from the first storage device to the second storage device, and writes a break instruction to the debugger by referring to the breakpoint information stored in the third storage device when the loading is completed.

In the above-described structure, there is such a form that the loader extracts, from the breakpoint information stored in the third storage device, a breakpoint that falls within an address range of an area to which the program is loaded, and writes a break instruction to the extracted breakpoint.

In the debug device structured in the manner described above, the breakpoint registering part in advance registers the breakpoint information on the third storage device before the debugger starts up the target. Then, when the program control part starts up the target, the loader reads out the program stored in the first storage device and loads it to the second storage device. After confirming that the loading is completed, the loader refers to the breakpoint information stored in the third storage device and writes the break instruction to the breakpoint which is stored in the second storage device in association with the breakpoint information. In this form, the break instruction is written after loading of the program is completed, so that it never happens that the break instruction is erased because of the load processing. The breakpoint information is registered prior to loading of the program, and the registration destination is the third storage device. Therefore, the debug operator can write the break instruction automatically to the breakpoint without considering the timing of loading. Moreover, the loader has a function of writing the break instruction. In other words, writing of the break instruction can be accomplished within the target without using the debugger. Therefore, it is possible to execute the writing processing in a shorter time than writing the break instruction via the debugger.

In the above-described structure, there is such a from that a unique identifier is added to the program and to the breakpoint information; and
the loader writes the break instruction to a breakpoint that matches the identifier of the loaded program.

With this form, searching is executed via the identifiers when there are a plurality of programs. Thus, it is possible to clearly distinguish the already loaded program and the loading-uncompleted program. Therefore, it never happens that the break instruction written earlier is erased by the program loaded thereafter.

Further, in the above-described structure, there is such a form that:
a unique identifier is added to the program and to the breakpoint information; and
the loader extracts a breakpoint that matches the identifier of the loaded program, and writes the break instruction to an absolute address that is obtained as a result of adding a start address of the program to an address held by the breakpoint.

In this structure, the address of the loading destination is determined at the time of loading. Thus, in the case of dynamic loading where the address of the loading destination is not determined before loading, it is possible to write a break instruction without considering the timing of loading the program and the address.

Furthermore, in the above-described structure, there is such a form that the first storage device or the second storage device also serves as the third storage device.

Moreover, in the above-described debug devices except for the one provided with the breakpoint registering part, there is such a form that the debugger further comprises an access break setting part which sets an access break when receiving from the loader a notification about completion of the loading. The “access break” refers to processing for halting the program when there is access made to a designated address while the program is being executed. This processing is different from the processing executed by the break instruction setting part. It is the processing executed by utilizing a function of the hardware of the target. In this form, the debug operator may write a break instruction by paying attention only to the program that the operator debugs, through a method for not allowing a break to be executed even if the same address is used as the data area when loading another program.

Further, in the above-described structure, there is such a form that:
a unique identifier and symbol information are added to the program; and
the debugger further comprises a symbol information managing table for managing the identifier and the symbol information, and a symbol information reading part, wherein
the symbol information reading part reads the identifier and the symbol information from the program to register those on the symbol information managing table, and subsequently reads an identifier and symbol information from another program to additionally register those on the symbol information managing table. With this form, it is possible to read the symbol information in a lump at a time even when there are a plurality of programs. Thus, even if the program to be executed is changed during the startup of the target, it is unnecessary to obtain the symbol information again. In addition, it becomes possible to execute the break instruction writing processing before starting up the target, so that the efficiency of debugging work can be improved.

In a system where a program is loaded to a memory capable of high-speed operation during startup for high-speed access, the present invention loads the program first and writes a break instruction thereafter. Thus, it is possible to prevent the break instruction from being erased because of the load processing. Therefore, the debug operator can write the break instruction automatically to the breakpoint without considering the timing of loading. As a result, the debugging work can be done easily, thereby improving the debugging work efficiency.

Further, it becomes possible to increase the speed of the break instruction writing processing by adding a break instruction writing function to the loader.

Furthermore, through providing the structure capable of reading a plurality of pieces of symbol information in a lump at a time, it becomes possible to execute the break instruction writing processing at an arbitrary timing without re-reading the symbol information in the middle of the operation, when executing debugging in the system that uses a plurality of programs. As a result, the efficiency of the debugging work can be improved.

The debug device according to the present invention is effective for executing debugging in a system that loads and executes a program during startup.

### BRIEF DESCRIPTION OF THE DRAWINGS

Other objects of the present invention will become clear from the following description of the preferred embodiments and the appended claims. Those skilled in the art will appreciate that there are many other advantages of the present invention made possible by implementing the present invention.

FIG. 1 is a block diagram for showing the structure of a debug device according to a first embodiment of the present invention;

FIG. 2 is a flowchart for showing the operation of a break instruction setting part according to the first embodiment of the present invention;

FIG. 3 is a flowchart for showing the operation of a break instruction setting part according to a second embodiment of the present invention;

FIG. 4 is a block diagram for showing the structure of a debug device according to a third embodiment of the present invention;

FIG. 5 is a block diagram for showing the structure of a debug device according to a fourth embodiment of the present invention;

FIG. 6 is a block diagram for showing the structure of a debug device according to a fifth embodiment of the present invention;

FIG. 7 is a block diagram for showing the structure of a debug device according to a sixth embodiment of the present invention; and

FIG. 8 is an illustration for describing a symbol information managing table according to the sixth embodiment.

### DETAILED DESCRIPTION OF THE INVENTION

Preferred embodiments of the present invention will be described hereinafter by referring to the accompanying drawings.

### First Embodiment

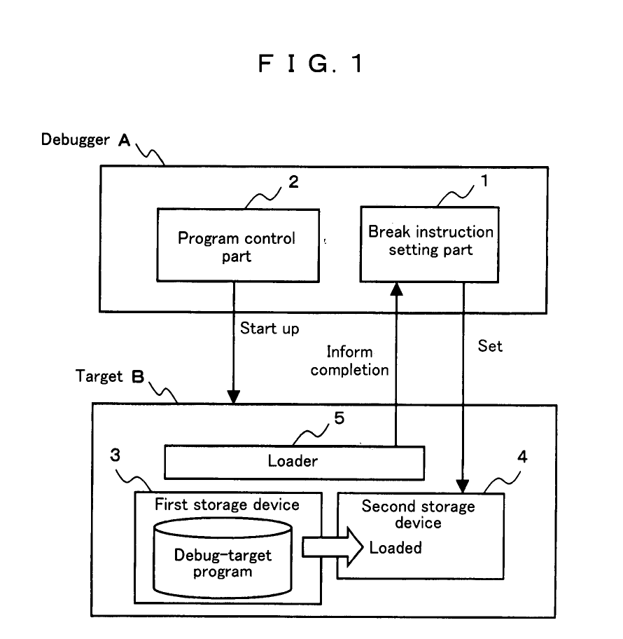

FIG. 1 is a block diagram for showing the structure of a debug device according to a first embodiment of the present invention. This debug device comprises a debugger A and a target B. The debugger A comprises: a break instruction setting part 1 which writes a break instruction to a breakpoint that is set in advance on a program that is a target of debugging; and a program control part 2 for starting up the program of the target B. “Break” herein refers to generally called “software break”, which can be achieved by rewriting an instruction that is written at a point where the operation of the executed program is desired to be halted so as to change it to a break instruction. The point where a break is caused is called a breakpoint, which is set by the debug operator. The breakpoint is managed with a breakpoint ID and an address. The address is an address value on a second storage device 4.

The target B comprises: a first storage device 3 for storing the program as the target of debugging; a second storage device 4 for loading the program to execute it; and a loader 5 which loads the program from the first storage device 3 to the second storage device 4, and informs the debugger A about the completion of loading when the loading is completed so as to request writing processing of a break instruction. The loader 5 loads the program that is in the first storage device 3 to the second storage device 4 while the target B is being executed. After completing the loading, the loader 5 informs the completion to the break instruction setting part 1 of the debugger A, and requests the break instruction writing processing. In this embodiment, the loader 5 informs an address range within which the program is loaded in the second storage device 4, when requesting the break instruction setting part 1 to execute the break instruction writing processing.

Upon receiving the request for the break instruction writing processing and the address range, the break instruction setting part 1 of the debugger A writes a break instruction to an address of a breakpoint which is included in the received address range out of the breakpoints set in advance by the debug operator. After the setting is completed, the target B is started up by the program control part 2 to restart the execution of the program.

The loader 5 may be specifically designed hardware such as a DMA (Direct Memory Access) or a program executed on a CPU (Central Processing Unit) of the target B.

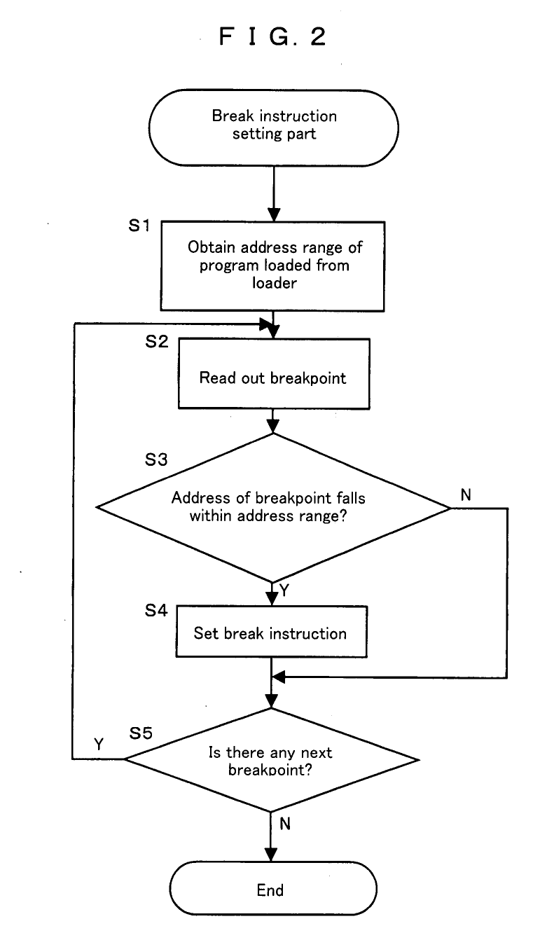

Next, the operation of the debug device according to this embodiment that is constituted in the above-described manner will be described by referring to FIG. 2. FIG. 2 is a flowchart for showing procedural steps of the processing executed by the break instruction setting part 1 of the debug device.

The debug operator sets the breakpoint in advance in the debugger A. The loader 5 of the target B reads out the program that is stored in the first storage device 3, and loads it to the second storage device 4. After confirming that the loading of the program has been completed, the loader 5 informs the completion of loading as well as the address range where the program is loaded to the break instruction setting part 1 of the debugger A. The address range data is constituted by a combination of the start address and the end address, a combination of the start address and the size, or the like. Further, the loader 5 requests the break instruction setting part 1 to execute the break instruction writing processing.

Upon receiving the notification regarding the completion of loading and the request for the break instruction writing processing, the break instruction setting part 1 performs the following processing, which will be described according to the flowchart of FIG. 2.

In step S1, the break instruction setting part 1 obtains the address range of the loaded program from the loader 5. In step S2, the break instruction setting part 1 reads out, one by one, the breakpoints that are set in advance by the debug operator. In step S3, the break instruction setting part 1 judges whether or not the address of the read-out breakpoint falls within the address range received from the loader 5. When the address is judged to be within the range, the procedure is advanced to step S4 and a break instruction is written to that breakpoint. On the other hand, if the address is out of the range, the step S4 is skipped and writing of the break instruction is not performed. In step S5, the break instruction setting part 1 judges whether or not there is a next-candidate breakpoint. When judged that there is, the procedure is returned to the step S2 to repeat the processing for reading out the breakpoint. After completing the processing for writing the break instruction to the breakpoint in the second storage device 4 in the manner described above, the program control part 2 of the debugger A starts up the target B.

As described above, the break instruction setting part 1 writes a break instruction to the breakpoint after the loader 5 loads the program to the second storage device 4. That is, it is defined to follow such an order that the program is loaded first, and the break instruction is written to the breakpoint thereafter. Therefore, it never happens that the break instruction is erased because of the load processing in a system where a program is loaded to the second storage device 4 capable of high-speed operation and executed thereon during startup due to high-speed access. As a result, the debug operator can write the break instruction automatically to the breakpoint without considering the timing of loading.

When there is a plurality of programs, the verification of an address range is useful. There is a corresponding relation between the loaded program and the address range in the loading destination, so that a break instruction is written to the loaded program. In the case where a break instruction is written to a given program after the program is loaded, and another program is written thereafter, the break instruction written earlier is not erased through the program loaded afterwards. In other words, in a system where a plurality of programs are loaded, it becomes possible to write a break instruction individually to each program even if each program is loaded to the same second storage device in different time zones.

In short, according to the present embodiment, the break instruction is written only to the already loaded program, so that it is possible to achieve the break as desired without the break instruction being erased by loading of a program even when there are a plurality of programs to be loaded.

### Second Embodiment

The structure of a debug device itself according to a second embodiment of the present invention is the same as that of the first embodiment that is shown in FIG. 1. In this embodiment, after loading the program from the first storage device 3 to the second storage device 4, the loader 5 informs the completion of loading and makes a request for the break instruction writing processing to the break instruction setting part 1, and also informs the break instruction setting part 1 about a program identifier and a start address of the second storage device 4, a loading destination. The start address herein means the start address of a loading destination of the loaded program.

It is assumed here that there is a plurality of programs, and the loader 5 determines at the time of execution to which area of the second storage device 4 each program is to be loaded. Therefore, the address used for designating the breakpoint in each program is a relative address from the top of the program. Further, the loader 5 is constituted to add a unique identifier to each program for making a distinction among the plurality of programs. For example, a number unique to each program is added to the program main body as the header information of the program. The break instruction setting part 1 is constituted to write a break instruction at the breakpoint that matches the informed identifier.

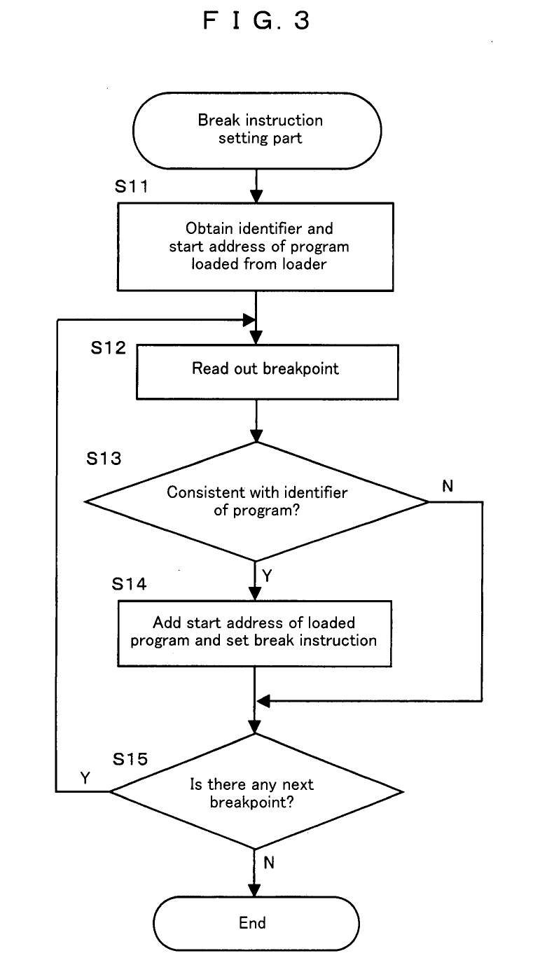

Next, the operation of the debug device according to the embodiment that is constituted in the above-described manner will be described by referring to FIG. 3. FIG. 3 is a flowchart for showing procedural steps of the processing that is executed by the break instruction setting part 1 of the debug device.

In step S11, the break instruction setting part 1 obtains the identifier of the program loaded by the loader 5 and the start address of the second storage device 4 to which the program is stored. In step S12, the break instruction setting part 1 reads out, one by one, the breakpoints that are set in advance by the debug operator from the second storage device 4. In step S13, the break instruction setting part 1 judges whether or not the identifier of the program at the target breakpoint matches the identifier of the program received from the loader 5. When judged as a result that the identifiers match, the procedure is advanced to step S14 to write a break instruction to an absolute address, which is obtained by adding the obtained start address of the loading destination, or the second storage device 4, to the address (relative address) that is held by the breakpoint information. In step S15, the break instruction setting part judges whether or not there is next breakpoint data. If there is, the procedure is returned to the step S12 to repeat the processing for reading out the breakpoint.

With this, under a state where there is a plurality of programs and the address of the loading destination is not determined before loading the program, the break instruction written earlier is not erased because of the program loaded thereafter. Thus, it is possible to achieve the break as desired.

### Third Embodiment

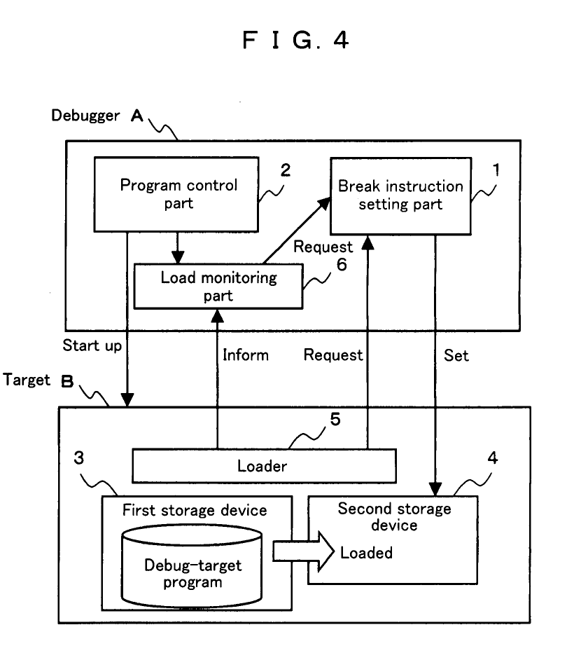

FIG. 4 is a block diagram for showing the structure of a debug device according to a third embodiment of the present invention. In FIG. 4, the same reference numerals as those of the first embodiment in FIG. 1 indicate the same structural elements. The structure peculiar to this embodiment is as follows.

The debugger A comprises a load monitoring part 6, in addition to the program control part 2 and the break instruction setting part 1. The program control part 2 is constituted to start up the load monitoring part 6 before the target is started up. The loader 5 of the target B informs the load monitoring part 6 of the debugger A about the completion of loading, after completing the loading of the program. The load monitoring part 6 stores information that the loading is completed when receiving a notification from the loader 5 about the completion of loading, and instructs the break instruction setting part 1 to write a break instruction if the loading of the program is completed at the time of receiving a start-up request from the program control part 2. Upon receiving the above-described instruction, the break instruction setting part 1 writes a break instruction to the breakpoint that is set in the second storage device 4. When the writing is completed, the program control part 2 starts up the target B to restart the execution of the program.

On the other hand, when the loading of the program is uncompleted, the load monitoring part 6 does not start up the break instruction setting part 1. That is, writing of a break instruction is not carried out. Other structures are the same as those of the first embodiment, so that the explanations thereof are omitted.

Next, the operation of the debug device according to this embodiment that is constituted in the above-described manner will be described. The loader 5 of the target B reads out a program stored in the first storage device 3 and loads it to the second storage device 4. Upon confirming that the loading is completed, the loader 5 informs the completion of loading to the load monitoring part 6 of the debugger A. Upon receiving such notification, the load monitoring part 6 stores information that the loading of the program is completed.

In the debugger A, the program control part 2 starts up the load monitoring part 6. When the started-up load monitoring part 6 has stored information that it has already been informed that loading is completed, the load monitoring part 6 instructs the break instruction setting part 1 to write a break instruction. The break instruction setting part 1 writes a break instruction to the breakpoint that is set in the second storage device 4 of the target B. When the processing for writing the break instruction to the breakpoint is completed, the program control part 2 of the debugger A starts up the target B. On the other hand, when the loading of the program is uncompleted, the load monitoring part 6 does not instruct the break instruction setting part to write the break instruction. That is, writing of the break instruction is not carried out.

With the embodiment as described above, for the already loaded program, a break instruction can be written without starting up the loader 5. Therefore, it is possible to shorten the time that is required to start the execution of the program.

### Fourth Embodiment

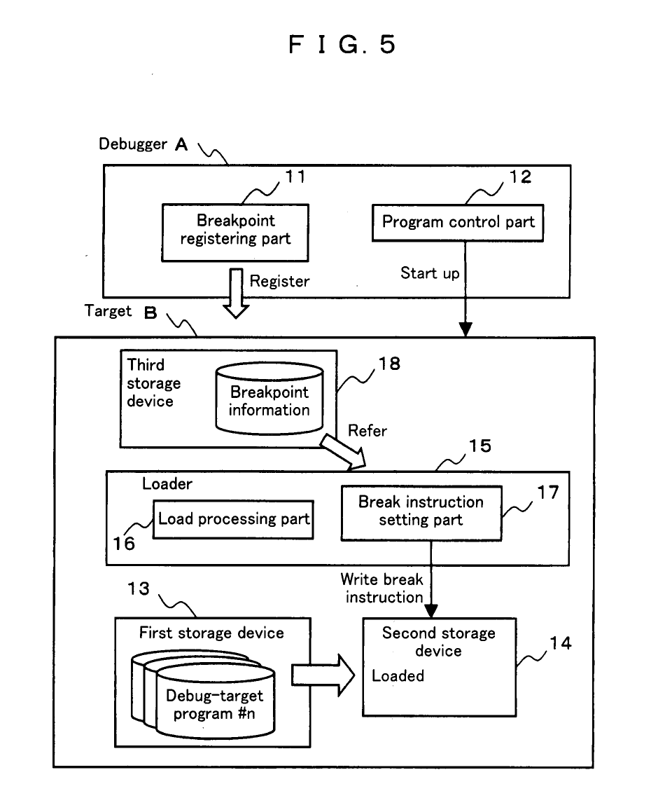

FIG. 5 is a block diagram for showing the structure of a debug device according to a fourth embodiment of the present invention. The debugger A according to this embodiment comprises a breakpoint registering part 11 for registering the breakpoint information, and a program control part 22 for starting up the program of the target B. The breakpoint information is constituted with a set of a breakpoint identifier, a program identifier, and an address, for example. When there is only a single program, the program identifier may not be necessary.

Further, the target B comprises: a first storage device 13 for storing a program as a debug target; a second storage device 14 for loading the program to execute it; a third storage device 18 for storing breakpoint information; and a loader 15 which loads the program from the first storage device 13 to the second storage device 14 and, when the loading is completed, writes a break instruction by referring to the breakpoint information stored in the third storage device 18. The loader 15 comprises: a load processing part 16 for performing load processing of the program; and a break instruction setting part 17 which extracts a breakpoint that falls within an address range of the area where the program is loaded by referring to the above-described breakpoint information, and writes a break instruction to the extracted breakpoint.

Next, the operation of the debug device according to the embodiment that is constituted in the above-described manner will be described. If the debug operator sets a breakpoint in advance before a startup of the target B by the debugger A, the breakpoint registering part 11 in the debugger A registers the breakpoint information to the third storage device 18 of the target B.

If the debug operator executes a command for starting the execution of the program in the state of having registered the breakpoint information to the third storage device 18 in advance in the above-described manner, the program control part 22 starts up the target B to start the execution of the program. The loader 15 of the target B reads out the program stored in the first storage device 13, and loads it to the second storage device 14. Then, upon confirming that the loading is completed, the break instruction setting part 17 of the loader 15 searches for the breakpoint information in the third storage device 18. If a breakpoint to be set on the loaded program is found as a result of comparison of the program identifiers, the break instruction setting part 17 writes a break instruction to the corresponding address in the second storage device 14.

When there is only a single program, the break instruction is written to the addresses of all the breakpoints that are registered on the breakpoint information. When there are a plurality of programs, the breakpoint that falls within the address range of the loaded program is searched for. Alternatively, when the program has the identifier, the breakpoint information having the same identifier as that of the loaded program is searched for. Further alternatively, when the address registered on the breakpoint information is a relative address from the top of the program, the break instruction is written to an absolute address that is obtained as a result of adding the value of the start address of the loading destination to the relative address. When writing of the break instruction is completed, the loaded program is executed.

As described above, the break instruction setting part 17 writes the break instruction to the breakpoint after confirming that the loading of the program is completed. Thus, the break instruction will never be erased because of the load processing. Further, when there are a plurality of programs, searching is executed via the identifiers. Thus, it is possible to clearly distinguish the already-loaded program and the loading-uncompleted program. Therefore, it never happens that a break instruction written earlier is erased through a program loaded thereafter.

Furthermore, the address of a loading destination is determined at the time of loading. Thus, in the case of dynamic loading where the address of the loading destination is not determined before loading, it is possible to write a break instruction without considering the timing of loading the program and the address.

In the embodiment, the breakpoint information is registered prior to loading of the program, and it is registered on the third storage device of the target. Therefore, the debug operator can write the break instruction automatically to the breakpoint without considering the timing of loading.

Moreover, as described above, the loader 15 has a function of writing the break instruction. Therefore, it is possible with the embodiment to set a breakpoint to the program that is to be loaded during the execution so as to perform a break. In other words, writing of the break instruction can be accomplished within the target B without using the debugger A. Therefore, it is possible to execute the writing processing in a shorter time than writing the break instruction via the debugger A. Although the breakpoint information herein is created in the third storage device 18, it may be created in the first storage device 13 or the second storage device 14.

### Fifth Embodiment

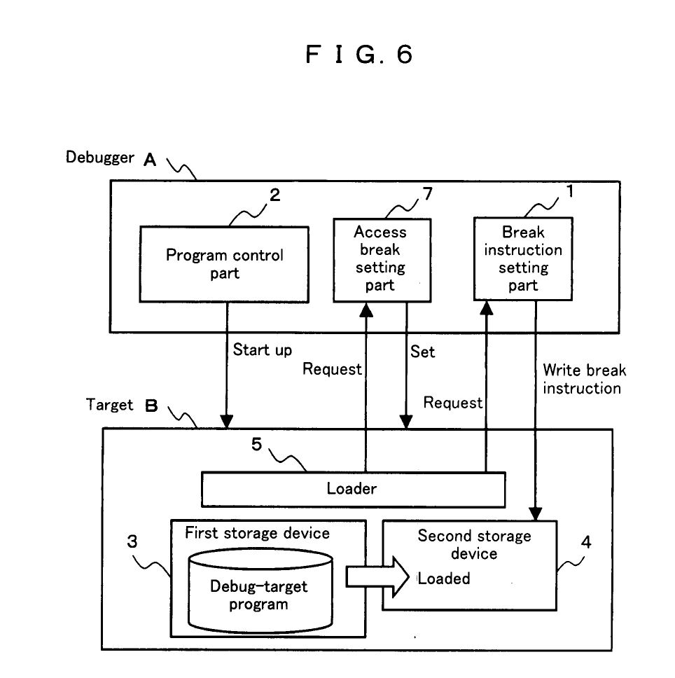

FIG. 6 is a block diagram for showing the structure of a debug device according to a fifth embodiment of the present invention. In FIG. 6, the same reference numerals as those of the first embodiment in FIG. 1 indicate the same structural elements. The structure peculiar to this embodiment is as follows.

The debugger A comprises an access break setting part 7 which sets an access break when informed by the loader 5 that the loading is completed, in addition to the program control part 2 and the break instruction setting part 1. The “access break” is a function for halting the program when there is access to a designated address while the program is being executed. Other structures are same as those of the first embodiment, so that explanations thereof are omitted.

Next, the operation of the debug device according to the embodiment that is constituted in the above-described manner will be described. The loader 5 informs the completion of loading to the access break setting part 7, when loading of the program is completed. Upon receiving a notification that the loading is completed, the access break setting part 7 sets an access break. The “access break” refers to processing for halting the program when data is read or written from/to a designated memory address while the program is being executed. This processing is different from the processing executed by the break instruction setting part 1. It is the processing executed by utilizing a function of the hardware of the target B. With the access break, the break instruction is not erased because of the load processing, unlike the case of the break instruction. The access break is effective when the address of a loading destination is determined at the time of loading. Further, the debug operator may write a break instruction by paying attention only to the program that the operator debugs, through a method for not allowing a break to be executed even if the same address is used as the data area while loading another program.

### Sixth Embodiment

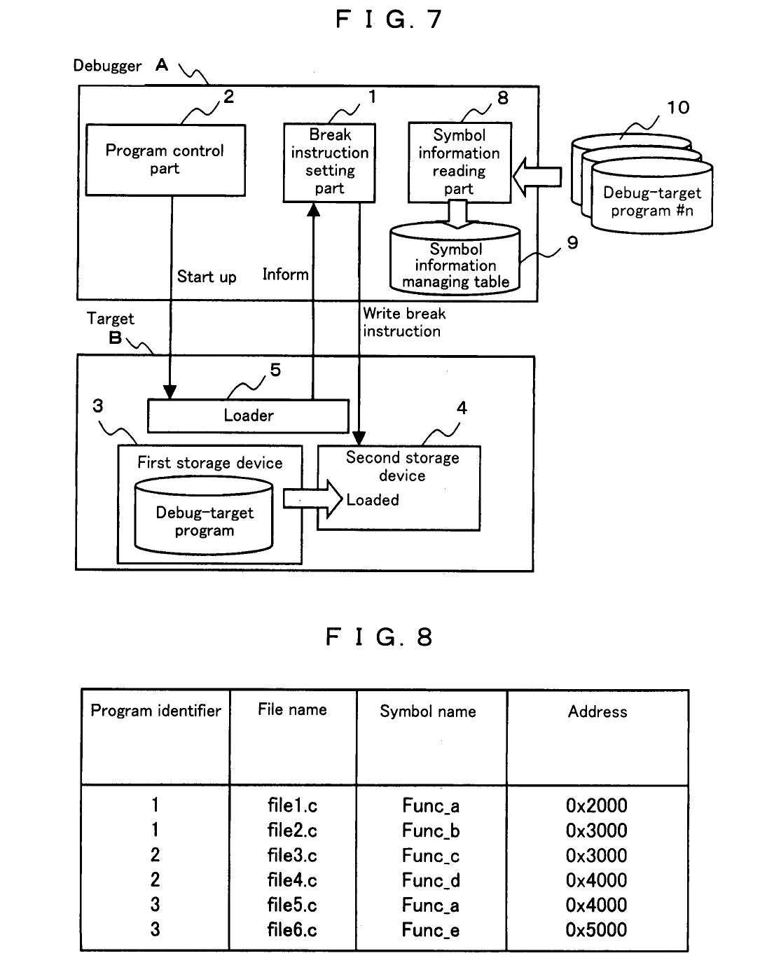

FIG. 7 is a block diagram for showing the structure of a debug device according to a sixth embodiment of the present invention. In FIG. 7, the same reference numerals as those of the first embodiment in FIG. 1 indicate the same structural elements. The structure peculiar to this embodiment is as follows.

In addition to the program control part 2 and the break instruction setting part 1, the debugger A comprises a symbol information reading part 8 which reads an identifier and symbol information from a debug-target program 10 and registers those on a symbol information managing table 9, and successively reads an identifier and symbol information from another program and additionally registers those on the symbol information managing table 9. The symbol information includes a function name, a global variable name, a source code file name, and the like. The symbol information is incorporated into the program file by a compiler when compiling the program. The symbol information reading part 8 reads the symbol information of a plurality of programs, and manages it on the symbol information managing table 9. FIG. 8 shows the contents of the symbol information managing table 9.

The symbol information managing table 9 manages four pieces of data as one set: the program identifier, the file name, the symbol name, and the address. The “address” herein is the address in the second storage device 4 in the case where the loading destination of a program has been determined at the time of incorporation, and it is the relative address from the top of the program in the case where the loading destination has not been determined. When the debug operator sets a breakpoint by using the function name (symbol name), the debugger A converts it to an address value by referring to the symbol information managing table 9, and creates a breakpoint managing table. When there is an overlap among symbol names as seen in the case of “Func_a” in FIG. 8, the debug operator designates the identifier or the file name with the symbol name. If the operator does not designate those, the debugger A outputs the candidates, and encourages the debug operator to designate the identifier.

When there are a plurality of programs, it is possible with the embodiment to read the symbol information altogether at a time. Furthermore, even if the program to be executed is changed during the startup of the target B, it is unnecessary to obtain the symbol information again. In addition, it becomes possible to write a break instruction before starting up the target, so that the efficiency of debugging work can be improved.

The present invention has been described in detail by referring to the most preferred embodiments. However, various combinations and modifications of the components are possible without departing from the spirit and the broad scope of the appended claims.

What is claimed is:

1. A debug device, comprising a debugger and a target, wherein:
said debugger comprises
a break instruction setting part which writes a break instruction to a breakpoint when receiving a request for executing break instruction writing processing, and
a program control part for starting up said target; and
said target comprises
a first storage device for storing a program as a debug target,
a second storage device which is a loading destination of said program, and
a loader which loads said program from said first storage device to said second storage device, and informs completion of loading to said debugger when said loading is completed so as to request said break instruction writing processing.

2. The debug device according to claim 1, wherein:
said loader informs said debugger about an address range of said second storage device to which said program is loaded, when requesting said debugger to execute said break instruction writing processing; and
said break instruction setting part writes said break instruction to said breakpoint that falls within said informed address range.

3. The debug device according to claim 1, wherein:
a unique identifier is added to said program;
said loader informs said debugger about said identifier of said loaded program, when requesting said debugger to execute said break instruction writing processing; and
said break instruction setting part writes said break instruction to a breakpoint that matches said informed identifier.

4. The debug device according to claim 1, wherein:
a unique identifier is added to said program;
said loader informs said debugger about said identifier of said loaded program and a start address of said second storage device to which said program is loaded, when requesting said debugger to execute said break instruction writing processing; and
said break instruction setting part writes said break instruction to an absolute address that is obtained as a result of adding said start address to a relative address held by breakpoint information.

5. The debug device according to claim 1, wherein said debugger further comprises a load monitoring part, wherein
said load monitoring part stores information that loading is completed when receiving a notification about completion of said loading from said loader, and instructs said break instruction setting part to execute said break instruction writing processing if said loading of said program is completed when receiving a startup request from said program control part.

6. A debug device, comprising a debugger and a target, wherein:
said debugger comprises
a breakpoint registering part for registering breakpoint information, and
a program control part for starting up said target; and
said target comprises
a first storage device for storing a program as a debug target,
a second storage device which is a loading destination of said program,
a third storage device for storing said breakpoint information, and
a loader which loads said program from said first storage device to said second storage device, and writes a break instruction to said debugger by referring to said breakpoint information stored in said third storage device when said loading is completed.

7. The debug device according to claim 6, wherein said loader extracts, from said breakpoint information stored in said third storage device, a breakpoint that falls within an address range of an area to which said program is loaded, and writes said break instruction to said extracted breakpoint.

8. The debug device according to claim 6, wherein:
a unique identifier is added to said program and to said breakpoint information; and
said loader writes said break instruction to said breakpoint that matches said identifier of said loaded program.

9. The debug device according to claim 6, wherein:
a unique identifier is added to said program and to said breakpoint information; and
said loader extracts a breakpoint that matches said identifier of said loaded program, and writes said break instruction to an absolute address that is obtained as a result of adding a start address of said program to an address held by said breakpoint.

10. The debug device according to claim 6, wherein said first storage device or said second storage device serves also as said third storage device.

11. The debug device according to claim 1, wherein said debugger further comprises an access break setting part which sets an access break when receiving a notification about completion of said loading from said loader.

12. The debug device according to claim 1, wherein:
a unique identifier and symbol information are added to said program; and
said debugger further comprises a symbol information managing table for managing said identifier and said symbol information, and a symbol information reading part, wherein
said symbol information reading part reads said identifier and said symbol information from said program to register those on said symbol information managing table, and subsequently reads an identifier and symbol information from another program to additionally register those on said symbol information managing table.

13. The debug device according to claim 6, wherein:
a unique identifier and symbol information are added to said program; and
said debugger further comprises a symbol information managing table for managing said identifier and said symbol information, and a symbol information reading part, wherein
said symbol information reading part reads said identifier and said symbol information from said program to register those on said symbol information managing table, and subsequently reads an identifier and symbol information from another program to additionally register those on said symbol information managing table.

14. A debug processing method, comprising the steps of:
a first step which loads a program from a first storage device to a second storage device, and informs completion of loading to said debugger when said loading is completed so as to request break instruction writing processing; and
a second step which writes a break instruction to a breakpoint when receiving a request for executing said break instruction writing processing.

15. The debug processing method according to claim 14, wherein:
in said first step, an address range of said second storage device to which said program is loaded is informed to said debugger, when requesting said debugger to execute said break instruction writing processing; and
in said second step, said break instruction is written to said breakpoint that falls within said address range that is informed to said debugger.

16. The debug processing method according to claim 14, wherein:
a unique identifier is added to said program;
in said first step, said identifier of said loaded program is informed to said debugger, when requesting said debugger to execute said break instruction writing processing; and
in said second step, said break instruction is written to a breakpoint that matches said informed identifier.

17. The debug processing method according to claim 14, wherein
a unique identifier is added to said program;
in said first step, said identifier of said loaded program and a start address of said second storage device to which said program is loaded are informed to said debugger, when requesting said debugger to execute said break instruction writing processing; and
in said second step, said break instruction is written to an absolute address that is obtained as a result of adding said start address to a relative address held by breakpoint information.

18. A debug processing method, comprising the steps of:
a first step which registers breakpoint information of a program on a third storage device; and
a second step which loads said program from a first storage device to a second storage device, and writes a break instruction to a debugger referring to said breakpoint information stored in said third storage device when said loading is completed.

19. The debug processing method according to claim 18, wherein, in said second step, a breakpoint included within an address range of an area to which said program is loaded is extracted from said breakpoint information stored in said third storage device, and then said break instruction is written to said extracted breakpoint.

20. The debug processing method according to claim 18, wherein:
a unique identifier is added to said program and to said breakpoint information; and
in said second step, said break instruction is written to a breakpoint that matches said identifier of said loaded program that.

21. The debug processing method according to claim 18, wherein:
a unique identifier is added to said program and to said breakpoint information; and
in said second step, a breakpoint that matches said identifier of said loaded program is extracted, and said break instruction is written to an absolute address that is obtained as a result of adding said start address of said program to an address held by said breakpoint.

22. The debug processing method according to claim 18, wherein, in said second step, an access break is set when receiving a notification about completion of said loading.
